(19) United States
(12) Patent Application Publication
(10) Pub. No.: US 2026/0187810 A1
(43) Pub. Date: Jul. 2, 2026

(54) INFORMATION PROCESSING

(71) Applicants: Lemon Inc., Grand Cayman (KY); Beijing Zitiao Network Technology Co., Ltd., Beijing (CN)

(72) Inventors: Xiangtai LI, Singapore (SG); Tao Zhang, Beijing (CN); Zilong Huang, Singapore (SG); Jiashi Feng, Singapore (SG)

(21) Appl. No.: 19/425,939

(22) Filed: Dec. 18, 2025

(30) Foreign Application Priority Data
Dec. 27, 2024 (CN) 202411967642.9

(51) Int. Cl. G06T 7/11; G06F 16/3329

(52) U.S. Cl. CPC G06T 7/11; G06F 16/33295

(57) ABSTRACT

Embodiments of the disclosure relate to a method, an apparatus, a device and a computer readable storage medium for information processing. The method provided herein includes: obtaining media content and user input information; and providing a segmentation result associated with an object in the media content in response to the user input information indicating a first request for segmenting the object, wherein the segmentation result is determined by a segmentation model based on the media content and a segmentation feature, and the segmentation feature is generated by a language model based on the media content and the user input information.

### CROSS REFERENCE

This application claims the benefits of Chinese Patent Application No. 202411967642.9, filed on Dec. 27, 2024, entitled “METHOD, APPARATUS, DEVICE AND STORAGE MEDIUM FOR INFORMATION PROCESSING”, the entire content of which is incorporated herein by reference.

### FIELD

Example embodiments of the present disclosure generally relate to the field of computers, and in particular, to information processing.

### BACKGROUND

With the development of computer technologies, some language models may support understanding of media content (e.g., images and videos). For example, some language models may support the generation of textual descriptions about images or videos, and some language models may support answering questions which are input by users based on images or videos.

### SUMMARY

In a first aspect of the present disclosure, a method for information processing is provided. The method includes: obtaining media content and user input information; and providing a segmentation result associated with an object in the media content in response to the user input information indicating a first request for segmenting the object, wherein the segmentation result is determined by a segmentation model based on the media content and a segmentation feature, and the segmentation feature is generated by a language model based on the media content and the user input information.

In a second aspect of the present disclosure, an apparatus for information processing is provided. The apparatus includes: an obtaining module configured to obtain media content and user input information; and a providing module configured to provide a segmentation result associated with an object in the media content in response to the user input information indicating a first request for segmenting the object, wherein the segmentation result is determined by a segmentation model based on the media content and a segmentation feature, and the segmentation feature is generated by a language model based on the media content and the user input information.

In a third aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect.

In a fourth aspect of the present disclosure, a computer-readable storage medium is provided. The computer-readable storage medium stores a computer program, and the computer program is executable by the processor to implement the method of the first aspect.

It should be understood that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numerals refer to the same or similar elements, in which:

FIG. 1 illustrates a schematic diagram of an example environment in which embodiments according to the present disclosure may be implemented;

FIG. 2A illustrates an example architecture of an information processing system according to some embodiments of the present disclosure;

FIG. 2B illustrates an example interaction scenario according to some embodiments of the present disclosure;

FIG. 3 illustrates a schematic block diagram of an example process of information processing according to some embodiments of the present disclosure;

FIG. 4 illustrates a schematic structural block diagram of an example apparatus for information processing according to some embodiments of the present disclosure; and

FIG. 5 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are illustrated in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be noted that the title of any section/subsection provided herein is not limiting. Various embodiments are described throughout and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms “including” and the like should be understood to be open-ended, that is, “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below. The terms “first,” “second,” and the like may refer to different or identical objects. Other explicit and implicit definitions may also be included below.

Embodiments of the present disclosure may relate to data of a user, obtaining and/or use of data, and the like. These aspects all follow the corresponding laws and regulations and relevant provisions. In the embodiments of the present disclosure, collection, obtaining, handling, processing, forwarding, use, and the like of all data are performed on the basis that the user knows and confirms. Accordingly, when implementing the embodiments of the present disclosure, the types of the data or information that may be involved, the scope of use, the usage scenario, and the like should be notified to the user and the authorization of the user is obtained in an appropriate manner according to the relevant laws and regulations. The specific methods for notification and/or authorization manner may vary according to actual situations and application scenarios, and the scope of the present disclosure is not limited in this respect.

In the present specification and solutions in the embodiments, if personal information processing is involved, processing may be performed on the basis of legitimacy (e.g., obtaining the consent of a personal information subject, or as necessary for the performance of a contract), and processing is only within a scope specified or agreed range. The user's refusal to allow processing of personal information not necessary for the basic functions, does not affect the use of the basic function by the user.

As introduced above, some existing language models may support generating textual descriptions about images or videos. In addition, some existing language models may support answering questions that user input based on images or videos. However, conventional models typically only support processing for single-type tasks or similar types of tasks.

The embodiment of the disclosure provides a solution for information processing. The solution includes: obtaining media content and user input information; and providing a segmentation result associated with the object in the media content in response to the user input information indicating a first request for segmenting the object, wherein the segmentation result is determined by a segmentation model based on the media content and the segmentation feature, and the segmentation feature is generated by the language model based on the media content and the user input information.

In this way, embodiments of the present disclosure can support multi-modal understanding of static and dynamic visual content by using the segmentation features generated by the language model to guide the segmentation model to generate precise masks.

Various example implementations of this solution are described in detail below in conjunction with the accompanying drawings.

### Example Environment

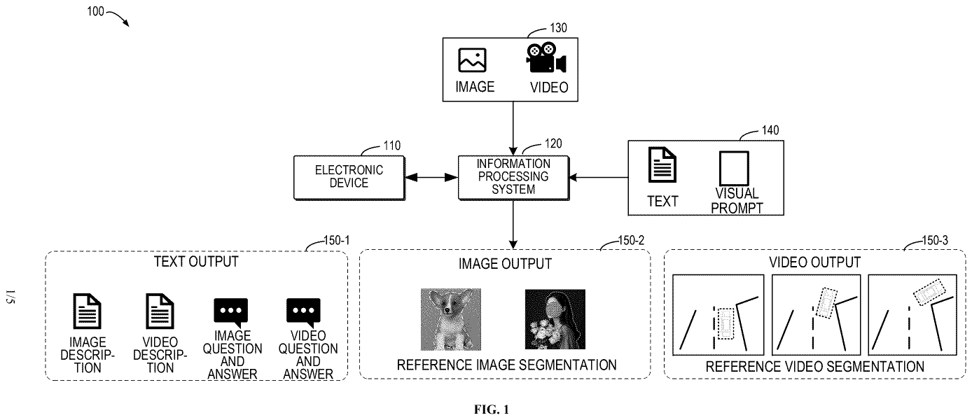

FIG. 1 illustrates a schematic diagram of an example environment 100 in which embodiments of the present disclosure may be implemented. As shown in FIG. 1, the example environment 100 may include an electronic device 110.

In this example environment 100, the electronic device 110 may deploy an information processing system 120. The information processing system 120 may obtain media content 130, which is also referred to as reference media content. The media content 130 may include, for example, image content, video content, and the like.

In addition, the information processing system 120 may also obtain user input information 140. As an example, the user input information 140 may include a text prompt and/or a visual prompt. As an example, the interaction interface of the information processing system 120 receives text content and/or voice content input by a user, thereby determining a corresponding text prompt.

As another example, the visual prompt may be determined based on interaction operation on the media content 130 by the user. For example, the user may click on a preset location in the media content 130 or add a preset annotation in the media content 130 by. Accordingly, the information processing system 120 may determine a corresponding visual prompt based on the operation of the user for the media content.

In some embodiments, the information processing system 120 may perform different types of tasks depending on the different requests expressed by the user input information 140. As an example, such tasks may include, but are not limited to, a picture description task, a video description task, an image question and answer task, a video question and answer task, an image segmentation task, a video segmentation task, and the like.

In the case of different tasks, the information processing system 120 may, for example, provide different types of inputs, such as a text output 150-1, an image output 150-2, or a video output 150-3.

As an example, if the user input information 140 indicates a request to generate a description of media content or a request to answer questions related to the media content, the information processing system 120 may provide the text output 150-1.

As an example, if the user input information 140 indicates a request for segmenting an object in the media content, the information processing system 120 may provide the image output 150-2 or the video generation 150-3 to indicate a segmentation result of the media content.

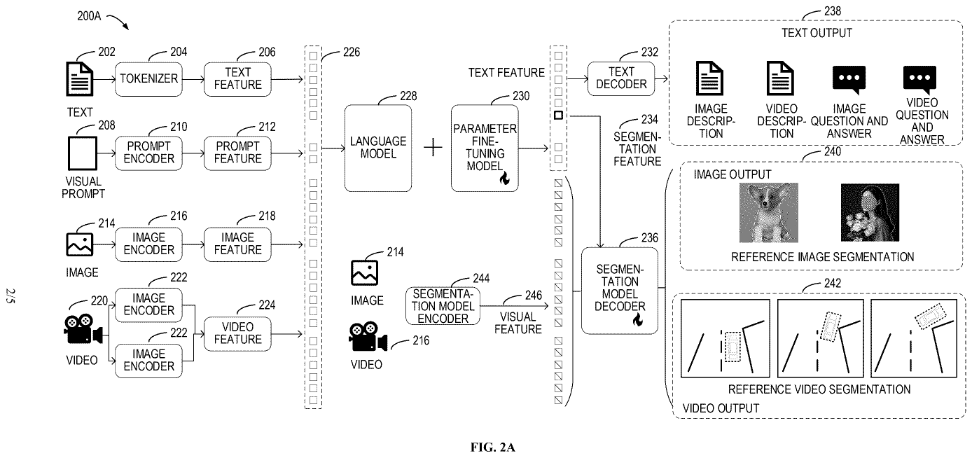

The specific structure and processing procedures of the information processing system 120 will be described in detail below with reference to FIGS. 2A and 2B.

The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, accessories and peripherals including these devices, or any combination thereof. In some embodiments, the electronic device 110 can also support any type of interface for a user (such as a “wearable” circuit, etc.).

The electronic device 110 may also be a standalone physical server, it may also be a server cluster or a distributed system composed of multiple physical servers, and may also be a cloud server that provides basic cloud computing services such as cloud services, cloud databases, cloud computing, cloud functions, cloud storage, network services, cloud communications, middleware services, domain name services, security services, content distribution networks, and big data and artificial intelligence platforms, and the like. The electronic device 110 may include, for example, a computing system/server, such as a mainframe, an edge computing node, a computing device in a cloud environment, or the like.

It should be understood that the structures and functions of individual elements in the environment 100 are described for illustrative purposes only without implying any limitation to the scope of the present disclosure.

Some example embodiments of the present disclosure will be described below with continued reference to the accompanying drawings.

### Example Information Processing System

FIG. 2A illustrates an example architecture 200A of an information processing system 120 according to some embodiments of the present disclosure. As shown in FIG. 2A, the information processing system 120 may include two models, namely a language model 228 and a segmentation model. The segmentation model may further include an encoder 201 and a decoder 236.

As shown in FIG. 2A, the information processing system 120 may provide a corresponding encoder for content of different modalities. As shown, if the user input information 140 includes a text 202 (e.g., a text prompt), the information processing system 120 may utilize a tokenizer 204 to determine a text feature 206 corresponding to the text 202.

In addition, if the user input information 140 includes the visual prompt 208, the information processing system 120 may utilize the prompt encoder 210 to determine a prompt feature 212 corresponding to a visual prompt 208.

If the provided media content 130 includes an image 214, the information processing system 120 may utilize the image encoder 216 to determine image features 218 corresponding to the image 214. If the provided media content 130 includes a video 220, the information processing system 120 may utilize an image encoder 222 to process different image frames of the video 220, thereby determining video features 224 corresponding to the video 220.

It should be understood that the image encoder 216 may be the same as or different from the image encoder 222.

Further, the information processing system 120 may construct a feature sequence 226 based on a first feature (e.g., an image feature 218 or a video feature 224) corresponding to the media content 130 and a second feature (e.g., a text feature 206 or a prompt feature 212) corresponding to the user input information 140.

The information processing system 120 may further input the feature sequence 226 to the language model 228. In some embodiments, if the user input information 140 indicates a first request for segmenting an object in the media content 130, the feature output by the language model 228 may include a segmentation feature 234.

As an example, the language model 228 may output a token corresponding to the segmentation feature 234 in a token prediction manner.

With continued reference to FIG. 2A, the decoder 236 of the segmentation model may generate a segmentation result of the media content based on the media content 130 and the segmentation feature 234. As an example, the encoder 244 of the segmentation model may process the media content 130 (e.g., an image 214 or a video 216) to generate a corresponding visual feature 246.

Further, the decoder 236 may generate a segmentation result based on the segmentation feature 234 generated by the language model 228 and the visual feature 246 generated by the encoder 244. As an example, such a segmentation result may include image output content 240 to indicate a segmentation result of the image 214. Alternatively, the segmentation result may further include video output content 242 to indicate a segmentation result of the video 220.

In some embodiments, the segmentation result may correspond to a mask of the object to be segmented in the media content. If the media content is video content, the segmentation result may include a mask of the object in the plurality of video frames of the video content to indicate its areas in the plurality of frames.

In some embodiments, the information processing system 120 may also process other types of tasks (such as a description task of the media content and/or a question and answer task of the media content) based on the unified model structure.

Different from the segmentation task, when processing the description task and/or the question and answer task, the information processing system 120 may generate a corresponding response content based on the text feature generated by the language model 228. For example, the information processing system 120 may use the text decoder 232 to process the text features output by the language model 228 and thus may obtain corresponding text output content 238.

As an example, such text output content 238 may include a description, e.g., a caption, for an image or a video. As another example, such text output content 238 may include answers to questions in the user input information 140.

In this way, by combining the segmentation model and the language model, embodiments of the present disclosure may unify text, images, and videos into a feature space of a shared language model. Furthermore, embodiments of the present disclosure can support multi-modal understanding of static and dynamic visual content by using the segmentation features generated by the language model to guide the segmentation model to generate precise masks.

A training process of the information processing system 120 will be further described below.

In some embodiments, the language model 228 may be a pre-trained language model. Further, the segmentation model and the parameter fine-tuning model 230 associated with the language model 228 may be jointly trained. As shown in FIG. 2A, parameters of the encoder 244 of the segmentation model may be fixed, and the decoder 236 and the parameter fine-tuning model 230 may be trained in coordination.

As an example, the parameter fine-tuning model 230 may include a LoRA (Low-Rank Adaptation) model to support optimizing an output result of the language model 228 with smaller scale parameters.

In some embodiments, the decoder 236 and the parameter fine-tuning model 230 may be cooperatively trained based on a training data set. As an example, the loss of training may be expressed as:

$${\begin{matrix}{ℒ}_{instruction} = {ℒ}_{text} + {ℒ}_{mask} , & {ℒ}_{mask} = ℒ\end{matrix}}_{CE} + {ℒ}_{DICE} \qquad ( 1 )$$

wherein Lₜₑₓₜ represents text loss associated with the output result of the language model, which is also referred to as text regression loss, and Lₘₐₛₖ represents segmentation loss associated with the mask output by the segmentation model, which is also referred to as mask loss. As an example, the mask loss Lₘₐₛₖ may include cross entropy loss L_{CE} and dice loss [symbol] _{DICE} at a pixel level, and the dice loss represents a similarity between the predicted segmentation result and a real label.

An interaction scenario associated with information processing system 120 will be described further below in conjunction with FIG. 2B. FIG. 2B illustrates an example interaction scenario 200B according to some embodiments of the present disclosure.

As shown in FIG. 2B, the information processing system 120 may receive media content 250 via an interaction interface. As an example, the media content 250 may include user-specified video content. For example, the user may input the access address of the video content. As another example, the media content 250 may further include video content uploaded by the user through the interaction interface.

Further, the information processing system 120 may further obtain a message 252 input by the user. As an example, the message 252 may include a text message or a voice message input by the user. As shown in FIG. 2B, the content of the message 252 is “please describe the content of the video”.

Accordingly, the information processing system 120 may use the language model 228 to generate reply content 254 for the message 252 based on a processing procedure of a video description task described above. The reply content 254 may include, for example, a text description of the image information in the video 250.

As another example, the information processing system 120 may also obtain a message 256 input by a user. As an example, the message 256 may include a text message or a voice message input by a user. As shown in FIG. 2B, the content of the message 256 is “how the vehicle in the video travels”.

Accordingly, the information processing system 120 may use the language model 228 to generate reply content 258 for the message 256 based on the processing procedure of a video question and answer task described above. The reply content 258 may include, for example, an answer to a question provided by the user based on the understanding of the video 250.

As yet another example, the information processing system 120 may also obtain a message 260 input by a user. As an example, the message 260 may include a text message or a voice message input by a user. As shown in FIG. 2B, the content of the message 260 is “please segment the vehicle in the video”.

Accordingly, the information processing system 120 may use the language model 228 and the segmentation model to process the message 260 based on the processing procedure of a video segmentation task described above. As an example, the response content provided by the information processing system 120 may further include a text 262 generated by the language model 228, which may be used to describe a segmentation result 264 determined by the segmentation model.

In addition, the information processing system 120 may also present the segmentation result 264 determined by the segmentation model in the interaction interface. As an example, the information processing system 120 may display an image area corresponding to an object (e.g., a vehicle) in a target style to indicate a segmentation result. As shown in FIG. 2B, the information processing system 120 may, for example, change the color of the area corresponding to the vehicle, or highlight the boundary of the area corresponding to the vehicle.

As shown in FIG. 2B, such a segmentation result may include a segmentation result of the vehicle in a plurality of video frames, thereby realizing tracking of a specific object in the video content.

Thus, embodiments of the present disclosure can support extensive image and video understanding tasks, including but not limited to visual question answering, image segmentation, fine-grained analysis of video content, and the like. In addition, the embodiments of the present disclosure can support the processing of a long video sequence, extend the processing capability thereof through a length extrapolation technology based on the language model, and further enhance the ability of the model to analyze the long video sequence.

### Example Process

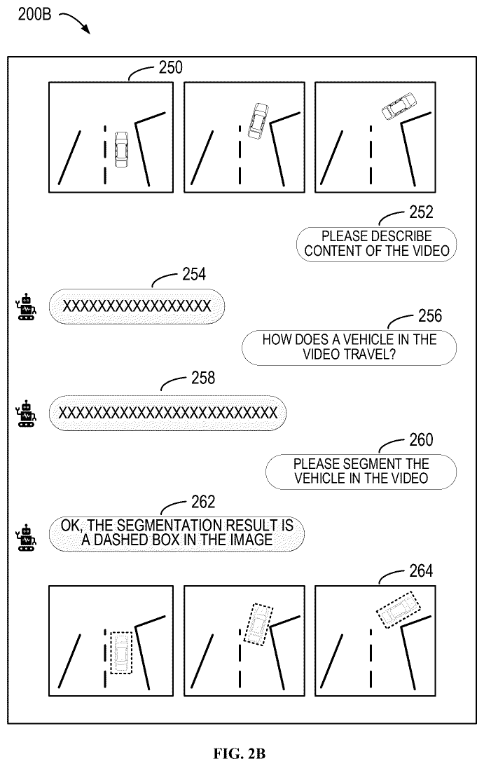

FIG. 3 illustrates a schematic diagram of an example information processing process 300 according to some embodiments of the present disclosure. The process 300 may be performed, for example, by the information processing system 120 as shown in FIG. 1.

As shown in FIG. 3, at block 310, the information processing system 120 obtains media content and user input information.

At block 320, the information processing system 120 provides a segmentation result associated with an object in the media content in response to the user input information indicating a first request for segmenting the object, where the segmentation result is determined by a segmentation model based on the media content and a segmentation feature, and the segmentation feature is generated by a language model based on the media content and the user input information.

In some embodiments, the segmentation feature is generated based on the following process: constructing a feature sequence based on the first feature corresponding to the media content and a second feature corresponding to the user input information; and inputting the feature sequence to the language model to generate the segmentation feature.

In some embodiments, the media content includes video content, and the segmentation result indicates an area of the object in the multi-frame image of the video content.

In some embodiments, the process 300 further includes: providing a target text generated by the language model based on the media content and the user input information in response to the user input information indicating a second request for generating text content associated with the media content.

In some embodiments, the target text includes at least one of the following: description for the media content; or an answer to a question in the user input information.

In some embodiments, providing the segmentation result associated with the object includes: displaying, in the media content, an image area corresponding to the object in the target style to indicate the segmentation result.

In some embodiments, the language model is further configured to generate a description text associated with the segmentation result.

In some embodiments, the user input information includes at least one of the following: a text prompt; or a visual prompt which is determined based on a preset operation on the media content.

In some embodiments, the language model is a pre-trained language model, and the segmentation model and a parameter fine-tuning model associated with the language model are jointly trained based on a text loss and a segmentation loss, the text loss is associated with an output result of the language model, and the segmentation loss is associated with a mask output by the segmentation model.

### Example Apparatus and Device

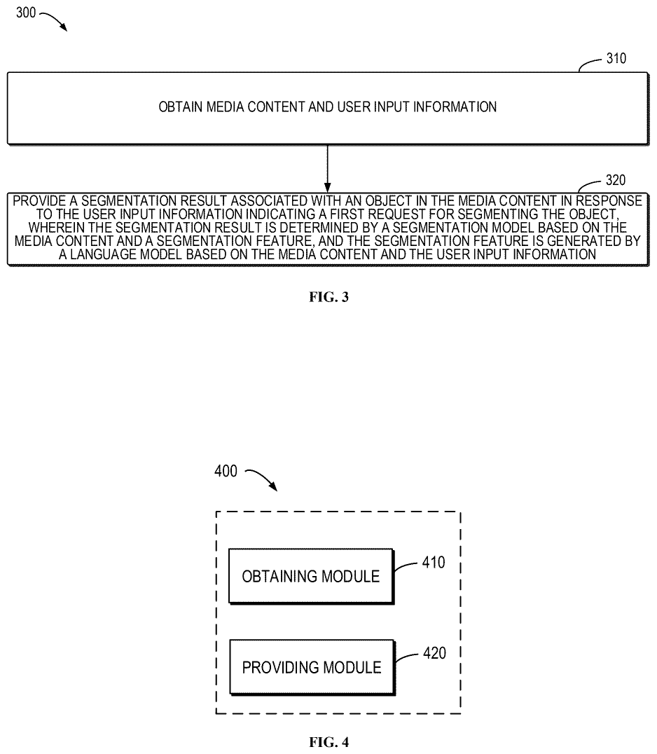

Embodiments of the present disclosure also provide a corresponding apparatus for implementing the above method or process. FIG. 4 illustrates a schematic structural block diagram of an example apparatus 400 for information processing according to some embodiments of the present disclosure. The apparatus 400 may be implemented or included in the electronic device 110. The various modules/components in the apparatus 400 may be implemented by hardware, software, firmware, or any combination thereof.

As shown in FIG. 4, the apparatus 400 includes an obtaining module 410 configured to obtain media content and user input information; and a providing module 420 configured to provide a segmentation result associated with an object in the media content in response to the user input information indicating a first request for segmenting the object, where the segmentation result is determined by a segmentation model based on the media content and a segmentation feature, and the segmentation feature is generated by a language model based on the media content and the user input information.

In some embodiments, the segmentation feature is generated to construct a feature sequence based on the first feature corresponding to the media content and a second feature corresponding to the user input information; and input the feature sequence to the language model to generate the segmentation feature.

In some embodiments, the media content includes video content and the segmentation result indicates an area of the object in a multi-frame image of the video content.

In some embodiments, the apparatus 400 further includes a processing module configured to provide a target text generated by the language model based on the media content and the user input information in response to the user input information indicating a second request for generating text content associated with the media content.

In some embodiments, the target text includes at least one of the following: description for the media content; an answer to a question in the user input information.

In some embodiments, the providing module 420 is further configured to display, in the media content, an image area corresponding to the object in a target style to indicate the segmentation result.

In some embodiments, the language model is further configured to generate a description text associated with the segmentation result.

In some embodiments, the user input information includes at least one of the following: a text prompt; a visual prompt, and the visual prompt is determined based on a preset operation on the media content.

In some embodiments, the language model is a pre-trained language model, and the segmentation model and a parameter fine-tuning model associated with the language model are jointly trained based on a text loss and a segmentation loss, the text loss is associated with an output result of the language model, and the segmentation loss is associated with a mask output by the segmentation model.

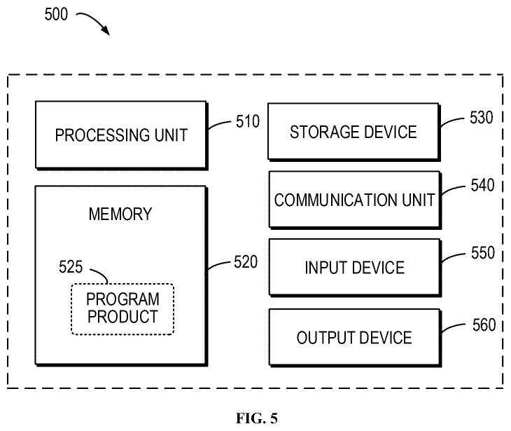

FIG. 5 illustrates a block diagram of an electronic device 500 in which one or more embodiments of the present disclosure may be implemented. It should be understood that the electronic device 500 illustrated in FIG. 5 is merely illustrative and should not constitute any limitation on the function and scope of the embodiments described herein. The electronic device 500 shown in FIG. 5 may be configured to implement the electronic device 110 in FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of the electronic device 500.

The electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. The storage device 530 may be a removable or non-removable medium and may include a machine-readable medium, such as a flash drive, a magnetic disk, or any other medium, which may be capable of storing information and/or data and may be accessed within the electronic device 500.

The electronic device 500 may further include additional removable/non-removable, volatile/non-volatile storage media. Although not shown in FIG. 5, a disk drive for reading from or writing to a removable, nonvolatile magnetic disk (e.g., a “floppy disk”) and an optical disk drive for reading from or writing to a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines which are capable of communication over a communication connection. Thus, the electronic device 500 may operate in a networked environment using logical connections with one or more other servers, network personal computers (PC), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, where the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by the processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium, these instructions cause the computer, programmable data processing apparatus, and/or other devices to function in a specific manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process, such that the instructions executed on a computer, other programmable data processing apparatus, or other apparatus implement the functions/acts specified in one or more blocks in the flowchart and/or block diagram.

The flowchart and block diagrams in the drawings show architecture, function, and operation of possible implementations of systems, methods, and computer program products according to various implementations of the present disclosure. In this regard, each block in the flowchart or block diagram may represent a module, a program segment, or a part of an instructions that includes one or more executable instructions for implementing the specified logical function. In some alternative implementations, the functions noted in the blocks may also occur in a different order than noted in the drawings. For example, two consecutive blocks may actually be performed substantially in parallel, which may sometimes be performed in the reverse order, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for information processing, comprising:
obtaining media content and user input information; and
providing a segmentation result associated with an object in the media content in response to the user input information indicating a first request for segmenting the object, wherein the segmentation result is determined by a segmentation model based on the media content and a segmentation feature, and the segmentation feature is generated by a language model based on the media content and the user input information.

2. The method of claim 1, wherein the segmentation feature is generated based on the following process:
constructing a feature sequence based on a first feature corresponding to the media content and a second feature corresponding to the user input information; and
inputting the feature sequence to the language model to generate the segmentation feature.

3. The method of claim 1, wherein the media content comprises video content and the segmentation result indicates an area of the object in a multi-frame image of the video content.

4. The method of claim 1, further comprising:
providing a target text generated by the language model based on the media content and the user input information in response to the user input information indicating a second request for generating text content associated with the media content.

5. The method of claim 4, wherein the target text comprises at least one of the following:
description for the media content; or
an answer to a question in the user input information.

6. The method of claim 1, wherein providing the segmentation result associated with the object comprises:
displaying, in the media content, an image area corresponding to the object in a target style to indicate the segmentation result.

7. The method of claim 1, wherein the language model is further configured to generate a description text associated with the segmentation result.

8. The method of claim 1, wherein the user input information comprises at least one of the following:
a text prompt; or
a visual prompt determined based on a preset operation on the media content.

9. The method of claim 1, wherein the language model is a pre-trained language model, and the segmentation model and a parameter fine-tuning model associated with the language model are jointly trained based on a text loss associated with an output result of the language model and a segmentation loss associated with a mask output by the segmentation model.

10. An electronic device comprising:
at least one processor; and
at least one memory coupled to the at least one processor and storing instructions for execution by the at least one processor, the instructions, when executed by the at least one processor, causing the electronic device to perform acts comprising:
obtaining media content and user input information; and
providing a segmentation result associated with an object in the media content in response to the user input information indicating a first request for segmenting the object, wherein the segmentation result is determined by a segmentation model based on the media content and a segmentation feature, and the segmentation feature is generated by a language model based on the media content and the user input information.

11. The electronic device of claim 10, wherein the segmentation feature is generated based on the following process:
constructing a feature sequence based on a first feature corresponding to the media content and a second feature corresponding to the user input information; and
inputting the feature sequence to the language model to generate the segmentation feature.

12. The electronic device of claim 10, wherein the media content comprises video content and the segmentation result indicates an area of the object in a multi-frame image of the video content.

13. The electronic device of claim 10, wherein the acts further comprise:
providing a target text generated by the language model based on the media content and the user input information in response to the user input information indicating a second request for generating text content associated with the media content.

14. The electronic device of claim 13, wherein the target text comprises at least one of the following:
description for the media content; or
an answer to a question in the user input information.

15. The electronic device of claim 10, wherein providing the segmentation result associated with the object comprises:
displaying, in the media content, an image area corresponding to the object in a target style to indicate the segmentation result.

16. The electronic device of claim 10, wherein the language model is further configured to generate a description text associated with the segmentation result.

17. The electronic device of claim 10, wherein the user input information comprises at least one of the following:
a text prompt; or
a visual prompt determined based on a preset operation on the media content.

18. The electronic device of claim 10, wherein the language model is a pre-trained language model, and the segmentation model and a parameter fine-tuning model associated with the language model are jointly trained based on a text loss associated with an output result of the language model and a segmentation loss associated with a mask output by the segmentation model.

19. A computer program product, the computer program product being tangibly embodied on a non-transitory computer-readable storage medium and comprising instructions that, when executed by at least one computing device, are configured to cause the at least one computing device to:
obtain media content and user input information; and
provide a segmentation result associated with an object in the media content in response to the user input information indicating a first request for segmenting the object, wherein the segmentation result is determined by a segmentation model based on the media content and a segmentation feature, and the segmentation feature is generated by a language model based on the media content and the user input information.

20. The computer program product of claim 19, wherein the segmentation feature is generated based on the following process:
constructing a feature sequence based on a first feature corresponding to the media content and a second feature corresponding to the user input information; and
inputting the feature sequence to the language model to generate the segmentation feature.
